(19) United States
(12) Patent Application Publication
(10) Pub. No.: US 2016/0266801 A1
(43) Pub. Date: Sep. 15, 2016

(54) A High Performance System and Method for Data Processing and Storage, Based on Low Cost Components, Which Ensures the Integrity and Availability of the Data for the Administration of Same

(71) Applicant: FONDO DE INFORMACIÓN Y DOCUMENTACIÓN PARA LA INDUSTRIA INFOTEC, Ciudad de México, Distrito Federal (MX)

(72) Inventors: Ricardo Marcelín Jemenez, Ciudad de México, D.F. (MX); Carlos Armando Pérez Enriquez, Ciudad de México, D.F. (MX)

(73) Assignee: Fondo de Información y Documentación para la Industria Infotec, Ciudad de México, DF (MX)

(21) Appl. No.: 14/787,753

(22) PCT Filed: Jan. 14, 2014
(86) PCT No.: PCT/MX2014/000005

§ 371 Date: May 16, 2016

(30) Foreign Application Priority Data
May 10, 2013 (MX) MX/A/2013/005303

(51) Int. Cl. G06F 3/06

(52) U.S. Cl. CPC G06F 3/0604; G06F 3/0613; G06F 3/0622; G06F 3/0629; G06F 3/0653; G06F 3/0683

(57) ABSTRACT

The present invention refers to a high performance system and method for data processing and storage, based on low cost components, which ensures the integrity and availability of the data for the administration of same, for its application in data centres, hospitals, schools, industries, libraries, technological centres, etc.

### PRIORITY INFORMATION

This application is a 371 U.S. Nationalization of International Patent (PCT) Application Serial No. PCT/MX2014/000005, filed on Jan. 14, 2014, which claims the benefit of Mexico Patent Application Serial No. MX/a/2013/005303, filed May 10, 2013, each of which are incorporated herein by reference in their entirety.

### FIELD OF THE INVENTION

The present invention refers to a high performance system and method for data processing and storage, based on low cost components, which ensures the integrity and availability of the data for the administration of same, for its application in computing centres, hospitals, schools, industries, libraries, technological centres, etc.

### BACKGROUND OF THE INVENTION

The present invention refers to a high performance system and method for data processing and storage, based on low cost components, which ensures the integrity and availability of the data for the administration of same, for application thereof in computing centres, hospitals, schools, industries, libraries, technological centres, etc.

Nowadays there is a very few knowledge of high performance systems and processes for the treatment and storage of information data, based on low cost components for its own administration. In most of these systems, sophisticated high storage equipments are required, which implies higher cost and a great emission of heat to the environment, contributing to global warming with.

In most of the systems that support massive information storage use very high cost specialized equipment, with a design that compels use of the same technology or brand whenever the system must to expand or grow.

Another problem associated to these systems is the great quantity of information they manage, that is, the more quantity of information, the more storage devices, contributing to use more physical space and this is a serious problem because most of enterprises have not an available space for this implementation.

The problem associated to massive storage has to do with systems scalability. This refers to the limitations to take steps for the storage capacities growth.

Situations like the aforementioned lead in the necessity to buy or rent two or more systems, making it very expensive and available only for big companies, leaving the small ones behind with all the prior issue.

As a result, small and medium organizations required to manage their own information typically don't have the means to arrange the systems, nor the processes for great volumes of information treatment and storage.

Among the acknowledged systems today there is the CEPH system [Weil, S. A., Brandt, S. A., Miller, E. L., Long, D.

D., & Maltzahn, C. (2006). CEPH: A scalable, high-performance distributed file system. In Proceedings of the 7th Symposium on Operating Systems Design and Implementation (OSDI}, (pp. 307-320)], CEPH is a distributed storage system initially developed in the University of California in Santa Cruz, this system is designed to bear the massive storage of scientific data, its design considers that there must be a very clear separation between data and metadata (the latter refers to information required to bear the administration of stored contents), this decision implies two principles:
first; there is no entry table to determine the place wherein a file has been hosted, and
second; the place where data is hosted is calculated by means of a pseudo-aleatory function.

However these two principles show that there is no need of a database wherein to register the device that storages the information, but that it can be calculated through a pseudo-aleatory function. While the system and process of this invention use a small database, called metadata, wherein a minimum quantity of information is kept, but it also requires a pseudo-aleatory function that, unlike the CEPH system, it may be changed depending on the version and architecture of each implementation.

The system GFS Ghemawat, S., Gobioff, H., & Leung, S.-T. (2003). The Google File System. Proceedings of the nineteenth ACM symposium on Operating systems principles (págs. 29-43). New York, N.Y., USA: ACM.], this system GFS (Google File System) was developed by Google Inc. in order to bear the necessities of the storage of its own organization. Among its design principles we can detail the fact that various servers are in charge of monitoring the system in order to detect failures, shot the recover procedures and refine the performance. The balance of load is made up breaking the files into fragments of fixed size. If a file exceeds this size, then it is divided in so many fragments as necessary to each may comply with this restriction. However, this GFS system is different to the system and process of this invention because, although it also uses a monitoring entity and a parameter maximum storage unit is defined called MSU, with a parametetizable size, that can be adapted to each application requirements, and we foresaw that the applications performance can be very sensible to this parameter, unlike the GFS system wherein cannot be parameterized.

The system HDFS [Shvachko, K., Kuang, H., Radia, S., & Chansler, R. (2010). The Hadoop Distributed File System. In Proceedings of the 26th IEEE Transactions on Computing Symposium on Mass Storage Systems and Technologies (MSST ‘10)], the HDFS (Hadoop File System) is a file system developed under the sponsorship of Yahoo for the Hadoop project context, each Hadoop node is a data store, and each data collection forms a cluster of data, communication between nodes is made by means of a TCP/IP layer, meanwhile the communication with the clients is made on the basis of RPC. HDFS uses the concept of fragmentation of files, in this case to guarantee the availability of information, copies of the same file are made (3 is the default replication value) and stored on different nodes. The HDFS considers one unique server or coordinator, called name node. However, in the system and process of the present invention there is a collection of nodes that we call storage cell. Each node is a logical device that resides in a machine. This has the storage capacity administrated by the node. In this sense, the node may be understood as a “storage virtual box”. Each machine may host several nodes. The machines, on the other hand, are connected to the coordinator or proxy by a local network. It is important to emphasize that each storage operation is based on local resources of the involved device, this means that the operation is performed regardless of the underlying storage technology or the local file system that manages it. The foregoing allows to integrate different operating systems (for example, Linux, MacOS, Windows and/or Unix) and storage technologies (for example SATA, NAS and/or SAS).

As well, the modular system design of the present invention enables to use versions and applications it can bear, unlike the HDFS system. It is also important to note that HDFS generates redundant information taking copies of the data that must be stored, meanwhile in the system of the present invention two alternative mechanisms are used to generate redundant information: multiple copy and the dispersion of information (IDA), it also uses a MSU of parameterzable size as we explained above. Finally, the system of the present invention considers the possibility to implement more than a coordinator or proxy, unlike the HFSD system.

The system Lustre [Schwan, P. (2003). Lustre, Building a file system for 1000 node clusters. Symposium, Linux.], is a distributed file system, developed at the Carnegie Mellon University. The Lustre system has three main functional units: i) a single metadata server, ii) a group of object storage servers and iii) the clients.

The metadata server keeps the name space which metadata is managed with, such as the names of files, directories, access permissions and the location of data. All metadata are managed in a single separate storage space and the object storage server contains one or more virtual spaces that share storage capabilities managed by the local file system. The Lustre system offers all its customers a standardized interface according to POSIX semantics standard, which bears concurrent read and write access on the files it manages. [symbol] Lustre's three functional units can be arranged on the same machine, but in a typical installation they are installed on different machines and communicated through a network. The architecture's network layer can arrange different communication technologies. The final storage is adapted to the file systems of managed volumes. However, regarding the system and process of the present invention there is a separation between the coordinator, storage devices and the application's client too. This invention system's design considers the possibility to implement more than one coordinator, each of them would be in charge of an instance of metadata, as well, the semantics of the interface is defined in the coordinator. In addition, another difference is that each storage device is able to maintain one or more virtual spaces called storage nodes. And for the final application, the local file system that each node works with is transparent.

The Cleversafe system uses the dispersion redundancy mechanism, based on the information dispersal algorithm or IDA. Optionally, the data may go through other processing types, such as encryption or compression. The processed data are stored in separate units, each of them has its own specifications for access and capacity. This is a technology that may be seen as an alternative to RAID-based systems and copying (replication) data storage. But the system of the present invention is different from this one, in that it is able to bear different methods of information processing; it offers redundancy based on multiple copying (3 copies are stored by default) or it uses IDA's own implementation, unlike Cleversafe system.

Among the patent documents referring to systems, there is the U.S. Pat. No. 5,485,474A document that describes a method and apparatus applicable to a variety of data storage, data communication, and parallel computing applications, efficiently improving information availability and load balance. Information to be transmitted in a data signal or stored is represented as N elements of a field or computational structure, and dispersed among a set of n pieces that are transmitted or stored in one not less than m pieces used in subsequent reconstruction.

For the dispersion, n vectors aᵢ, constructed with m elements each are used and the n pieces are assembled from the elements obtained as products of these vectors with m element groups taken from the N elements representing the information. For reconstruction from m available pieces, m-element vectors αᵢ are derived from the vectors aᵢ, and the N elements representing the information are obtained as products of these vectors with the m-element groups taken from the pieces.

The vector products may be implemented using an appropriate processor, including a vector processor, systolic fix up, or parallel processor.

For fault-tolerant storage in a system partition or distribution system, the information is dispersed into n pieces so that any m is enough for reconstruction, and the pieces are stored in different parts of a medium.

For fault-tolerant and congestion-free transmission of packages in a network or a parallel computer, each package is dispersed into n pieces so that any m pieces suffice for reconstruction and the pieces are routed to the package's destination along independent routes or in different times.

The information dispersal algorithm (IDA) transforms a fragment in n data units called dispersals or blocks, such that any m of them are enough to reconstruct the original unit. Evidently n>m>1. The algorithm involves the dispersion and reconstruction functions. The relation between parameters n and m performs an important role defining the amount of redundant information and fault tolerance. When m is close to n, then the algorithm bears few losses, but also requires few redundant information. When m is close to 1, the algorithm bears a greatest number of losses, but produces a very large amount of redundant information. And n must be greater than or equal to 3.

The elements of this system are also different from the elements which form the system of the present invention, so it is considered that this patent document does not advance or suggest the system of the present invention.

However the particular implementation used in the present invention is based on the finite field GF (2³) generated from the primitive polynomial g(x)=x⁸+x⁶+x⁵+x⁴+1 and uses a dispersion matrix of 5 rows by 3 columns as that shown below.

$$\begin{matrix}1 & 3 & 2 \\ 1 & 1 & 1 \\ 2 & 3 & 1 \\ 2 & 2 & 3 \\ 2 & 3 & 3\end{matrix}$$

Therefore the system and processes of the present invention have an implementation of the algorithm itself unlike the foregoing document.

The document EP 1146673 describes a generic information service structure is assumed and a method to transmit the information service from a server side to an unlimited number of users over a transmission medium is provided. This transmission method includes the following steps: -performing a fragmentation within each of categories representing said information service to create data fragments, -the addition of signalization information to each data fragment, which signalizing information allows a consistent assembly of said data fragments to a receiver on the basis of the established protocol rules, to create respective transmission objects, and -transmission of said diffusion objects in an order according to an information content of said data fragment within said transmitted object. Preferably, said fragmentation is performed dependent on the information content of the data to transmit. However this document does not mention or suggest the system of the present invention because formats, standards and protocols producing the packages are different, thereby it is considered that this document does not affect the novelty nor inventive activity of the present invention.

The above mentioned documents mentioned do not affect the novelty nor the inventive activity of the high performance system and process for the treatment and storage of data, based on low cost components, that guarantees integrity and availability of data for its own administration, because they have technical characteristics not mentioned nor suggested in the foregoing documents.

### BRIEF DESCRIPTION OF THE FIGURES

FIG. 1 represents the system of the present invention, showing the proxy, nodes, the switch, the monitor and the client.

FIG. 2 shows the information flow of the system of the present invention, in which arrow 1 represents the client who sends a request to the proxy, in arrow 2 the proxy sends a storage request to the node, in arrow 3 the node sends the file fragments to other nodes and in arrow 4 each node receiving fragments sends the blocks.

FIG. 3 shows the time sequence diagram of the storage of an information file in the system of the present invention.

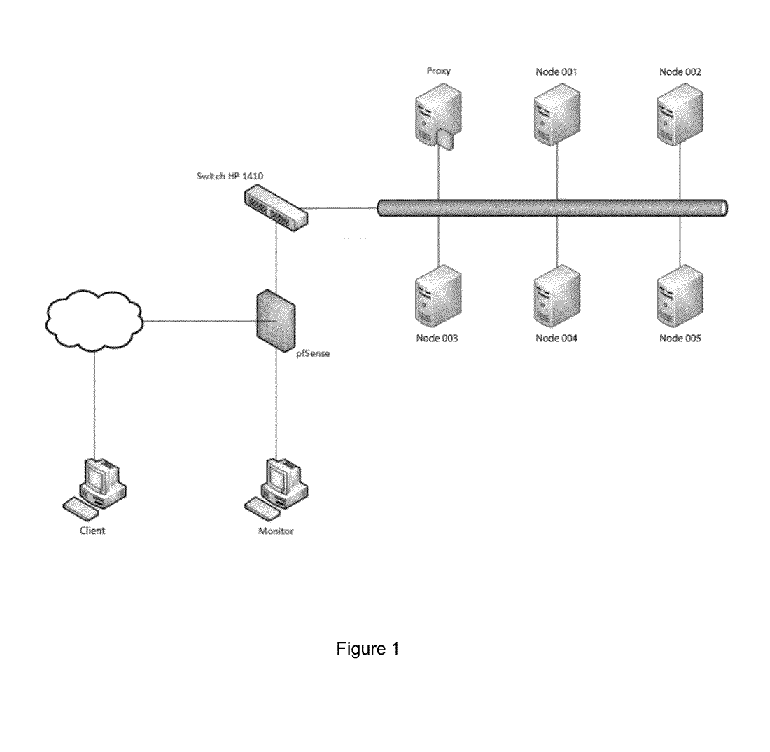

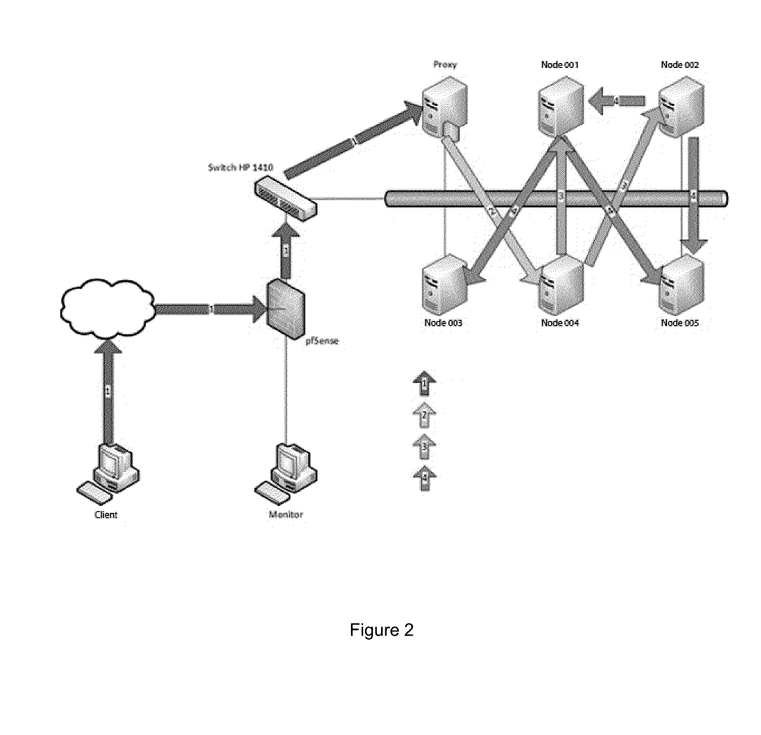

FIG. 4 represents the architecture components diagram of the system of the present invention wherein the Proxy functionality, the node and the monitor are described:
Proxy or coordinator: Is in charge to receive and route clients requests to the nodes.

It consists of the following modules:
Configuration and control: It stores the storage cell configuration and includes control process that can be sent to the nodes.
Index/Metadata: It contains the metadata related to files stored in the cell.
Access control: It has the responsibility to allow or deny the access to files according to the cell configuration and the clients.
Query engine: It supports a set of query operations to store, recover and looks for files.
Load balance: It allows to distribute the load in a just way between the nodes.
Synchronization engine: It allows the coherent existence of various coordinators replicating metadata among this set.
Node: They are the main “workers” of the cell, in charge mainly to process, store and retrieve the data corresponding to the files stored in the cell. Its main components are:
Communications: A subsystem in charge to receive requests from the coordinator and other nodes, as well as request data or assign work to other nodes.
Processing: It processes requests for storage or petitions received by this node.
Storage: It represents the physical device where data is stored.
Monitor: It is in charge to supervise the condition of the other components, in order to maintain them always in function when introduce them in case of failure, and/or notifying the superuser if necessary is.

FIG. 5 shows the diagram of components of the prototype of the present invention for its application in a Corporate memory.

FIG. 6 shows the class diagram of the prototype of the present invention for its application in a medical imaging storage system (PACS: Picture Archiving and Communications System), according to the DICOM standard (Digital Imaging and Communications in Medicine).

FIG. 7 shows the diagram of components of the prototype of the present invention for its application in a medical imaging system (PACS). It is observed the acquisition of devices, such as X-ray, IVUS, OCT, CT, called application entities, the proxy or storage server, taking as operating base, or core, a communications network and a set of software applications that obey the standard DICOM (Digital Imaging and Communications in Medicine).

FIG. 8 shows the sequence diagram to store a DICOM information object in the module or storage cell of the system of the present invention.

FIG. 9 shows the sequence diagram for query and retrieval of DICOM information objects of the system of the present invention.

### DESCRIPTION OF THE INVENTION

The present invention refers to a high performance system and method for data processing and storage, based on low cost components, which ensures the integrity and availability of the data for the administration of same, for its application in computing centres, hospitals, schools, industries, libraries, technological centres, etc.

The performance system and method for data processing and storage, based on low cost components, which ensures the integrity and availability of the data for the administration of same, of the present invention may be called too “storage cell” system and has a design that serves the requirements for confidence, scalability and performance.

The high-performance system includes the following modules: i) A control module; ii) A communications module; iii) A storage module; iv) A security module or firewall; and v) A monitor module.

The high-performance process includes the following stages: i′) Fragmentation; ii′) Replication; iii′) Information dispersal algorithm (IDA); iv′) Generation and verification of integrity sequence; v′) The Oracle; and vi′) Data Storage.

In a first mode, the performance system and method for data processing and storage, based on low cost components, which ensures the integrity and availability of the data for the administration of same, of the present invention includes the following modules:

i) A control module;

ii) A communications module;

iii) A storage module;

iv) A security module or firewall; and

v) A monitor module

The system of the present invention is operated by a control module by one or several coordinators or proxies.

Each proxy manages and coordinates the operation of the storage nodes and serves the service requests from clients, such as storing and retrieving files. Each proxy bears the different application interfaces that guarantee the system interoperability.

The number of proxies depends on the application and the incoming traffic that may be received from the service requests, but its number can vary from 1 to 5.

The modules of the system of this invention are interconnected via a communications module, by a data switch that can be implemented with different technologies, including twisted pair, coaxial cable and optical fiber.

The number of devices that can communicate the switch varies approximately from 6 to 32.

The storage module is formed by a set of machines equipped with storage capacity connected by the data switch, forming a local network.

Each machine has a 500 MB disk and can host two more disks.

Each machine can host one or more nodes.

Each node is a logical device and can be understood as a storing “virtual box”. The storage operations are based on local resources of each node involved.

The operation is performed regardless of the underlying storage technology or the local file system that manages it.

The foregoing allows to integrate the different operating systems such as Linux, MacOS, Windows and/or Unix and storage technologies such as SATA, NAS and/or SAS.

The firewall is a hardware and software module transparent to the application client, but validates the access to each proxy in order to avoid malicious users may damage it. When a user connects to the website where the system's public address or storage cell is, apparently the user connects to the proxy, but the user does not know that before communicating with, the firewall checks its communication and authorizes the proxy may accede to.

The monitor is another module after the firewall and is responsible for supervising the operations taking place in each proxy and storage node.

Physically it can be on the same machine as the proxy or in a machine connected to the cell by the same switch that connects all other components.

In a second mode, the process for the treatment of information in the system of this invention includes the following stages:
i′) Fragmentation;
ii′) Multiple copying;
iii′) Information dispersal algorithm (IDA);
iv′) [symbol] Generation and verification of the integrity sequence;
v′) The Oracle, and
vi′) Data storage.

Stage i′) Fragmentation, is a function that divides one file into smaller size data units, called fragments, and adds to each of them the information needed to perform the inverse operation, that is, the reassembly of the original file. Fragmentation is a function implemented and that invoked in each storage node.

Stage ii′) Replication, is a function that receives a fragment and produces several copies, called blocks. The number of blocks is a function parameter related to the amount of redundant information that seeks to ensure with the integrity of the fragment, in case of damage to the original data. This function is implemented and invoked from any of the storage nodes.

The stage iii′) of dispersion information algorithm (IDA), turns a fragment into n data units called dispersals or blocks, such that any m of them are enough to reconstruct the original unit.

The information dispersal algorithm (IDA) transforms a fragment in n data units called dispersals or blocks, such that any m of them are enough to reconstruct the original unit. Evidently n>m>1. The algorithm involves the dispersion and reconstruction functions. The relation between parameters n and m performs an important role in defining the amount of redundant information and tolerance to faults. When m is near to n, then the algorithm bears a greater number of losses, but produces a great amount of redundant information. Also n has to be greater or equal to 3.

The particular implementation of the cell is based on the finite field GF (2³) generated from its primitive polynomial g(x)=x⁸+x⁶+x⁵+x⁴+1 and uses a dispersion matrix of 5 rows by 3 columns as that shown below.

$$\begin{matrix}1 & 3 & 2 \\ 1 & 1 & 1 \\ 2 & 3 & 1 \\ 2 & 2 & 3 \\ 2 & 3 & 3\end{matrix}$$

The information dispersal algorithm, or IDA, is a function implemented and invoked in each storage node.

The stage iv′) of generation and verification of integrity sequence, the integrity verification function is a mechanism to detect corruption of the stored blocks. An algebraic processing information is performed to generate a sequence of bits that are concatenated with the original information. After that it has been stored or transmitted, a similar process may be used and to compare the resulting verification sequence accompanying the data. If these do not coincide, means that said data has been corrupted. In which case the data unit must be rejected.

In the implementation, the verification procedure of the blocks integrity is performed by the cyclic redundancy code CRC-32 defined by the ITU-T. This function is introduced and can be invoked from each storage node.

The Oracle stage v′) has the purpose to guarantee the processing load balance and the information storage. The oracle is an important component of the system of the present invention because it can accept different algorithms that ear the same function, the oracle is implemented as a hash function of dispersion, that receives the identifier of a data unit that must be processed or stored and as answer returns the identifier of the node that this duty can be commissioned to.

It is very important to guarantee that each block coming from the same fragment is stored in nodes hosted in different machines (independent). We call this condition “blocks assignation requirement”. The oracle must guarantee the blocks allocation requirement. The oracle is a function implemented and invoked in each proxy and storage node.

The data storage Stage vi′) in its turn includes the following stages:

a) A file storage;

b) A file recovery;

c) Replacing a failing machine, and

d) Scaling or expansion of storage capacities.

The stage a) includes the following steps:

a1) An user contacts a proxy of the control module;

a2) The proxy validates him as an authorized user;

a3) As the user submits his file with the information, the coordinator assigns him a single identifier and then creates a data stream between his computer and a storage node. The node selection is decided invoking the oracle, which guarantees the process load balance and the information location. The coordinator records this operation in a local database called metadata, in order to bear the future information recovery he receives;

a4) The storage module has a configurable parameter called maximum storage unit (MSU), to improve processing balance and storing. When the selected node starts receiving the data stream, divides itself into many fragments as necessary to guarantee that the length of each fragment does not exceed the given MSU. Each fragment's size may vary between 0.5 MB up to 500 MB;

a5) The node in charge after fragment the file it receives, invokes the oracle again to assign the process of new data units (fragments) to the other nodes involved in the storage cell;

a6) Each node receiving a fragment may subject it to a series of processing stages that depend on the profile of the user requests the service. In any case, we will call as blocks the data units resulting from this stage. The system bears two alternative treatments: replication or the information dispersal algorithm (IDA). Depending on the service level agreed with each user, the node receiving a fragment selects one of them.

Multiple replication creates n identical copies of the fragment. This is a variable parameter, but it has a default value equal to 3.

Instead, dispersal creates a set of n different bits chains, also called blocks, such that the original fragment can be recovered provided that any m blocks are available.

It is important to note that both functions parameters are configurable. In the case of IDA, the only condition is that 1<m<n. In the current implementation of IDA the values are m=3 and n=5.

a7) For each resulting block an integrity verification function is invoked, using a cyclic redundancy code (CRC ITU-T of 32 bits), the resulting chain concatenates at the end of each block and serves to control—when it is recovered—that the block has not been damaged. After this last treatment the blocks are stored in the system's nodes invoking the oracle again. It is very important to ensure that each of the blocks coming from the same fragment is stored in nodes residing in different machines. We call this condition blocks allocation requirement. Furthermore storing the blocks, each node generates local metadata that is stored in the same node and in an additional node (determined by the oracle) for its support, and

a8) [symbol] The node designated to process or store an information unit (file, fragment or block) confirms to the immediate source it has received the order from, when it has completed its duty.

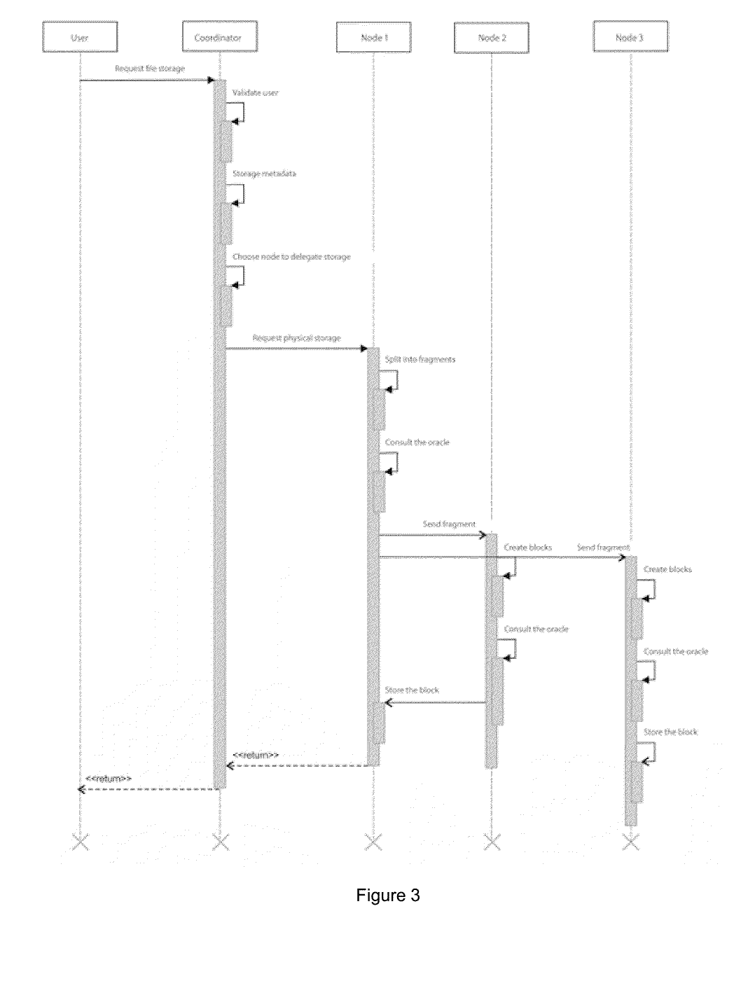

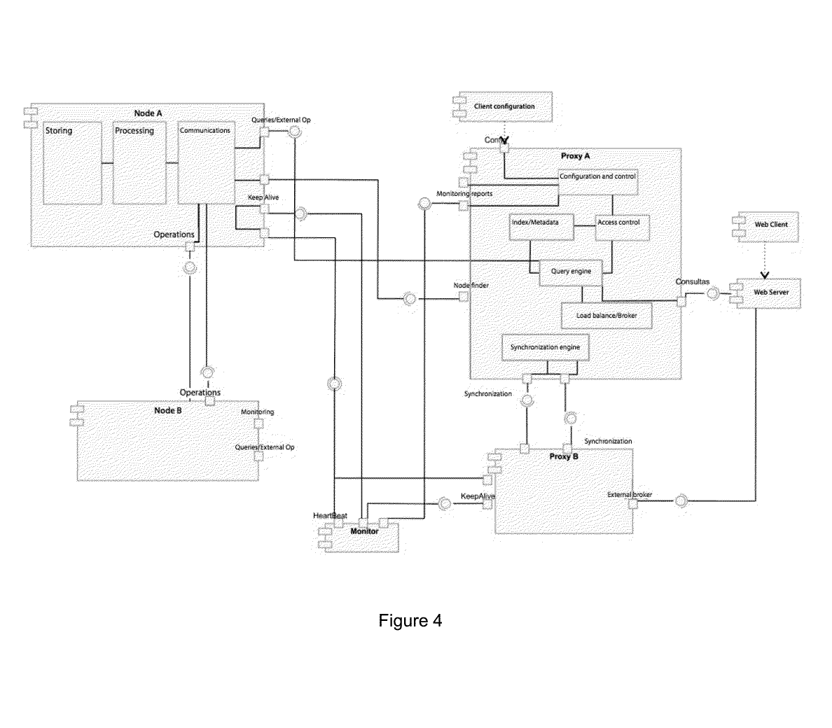

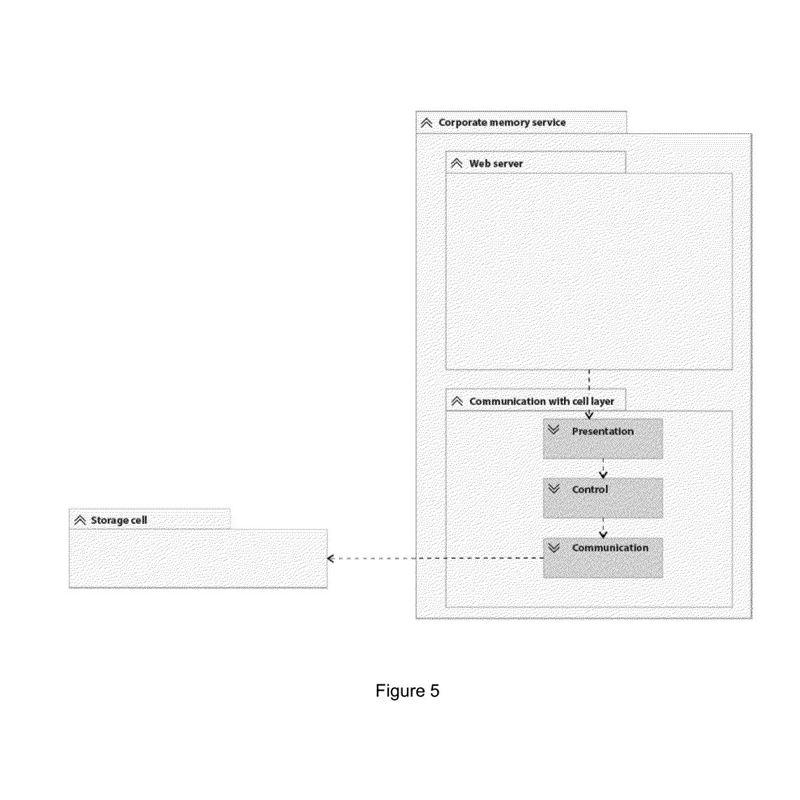

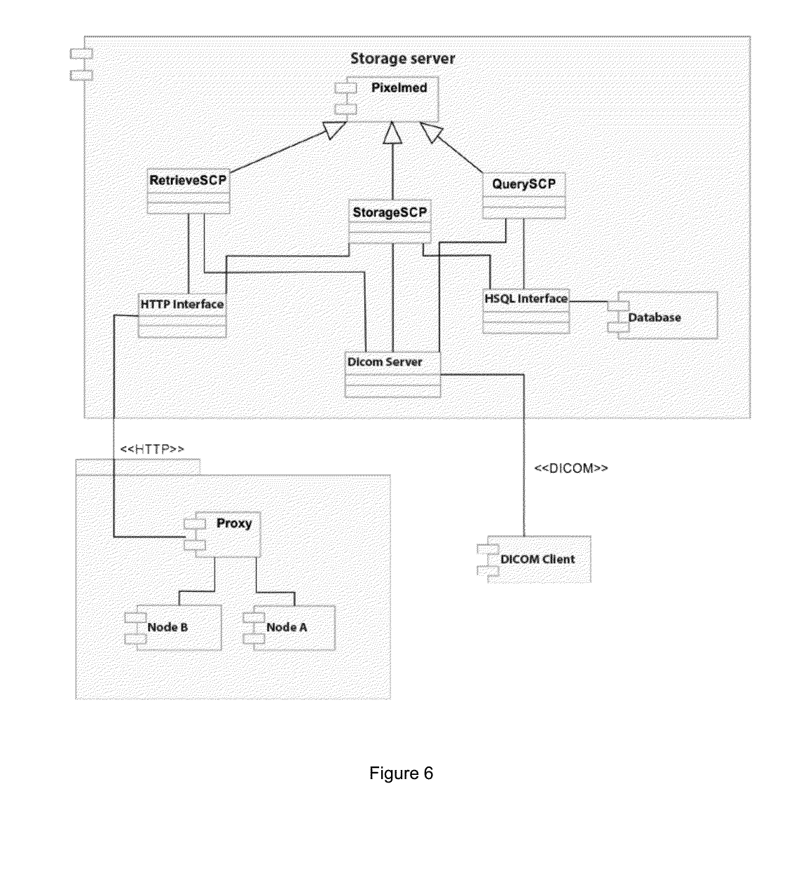

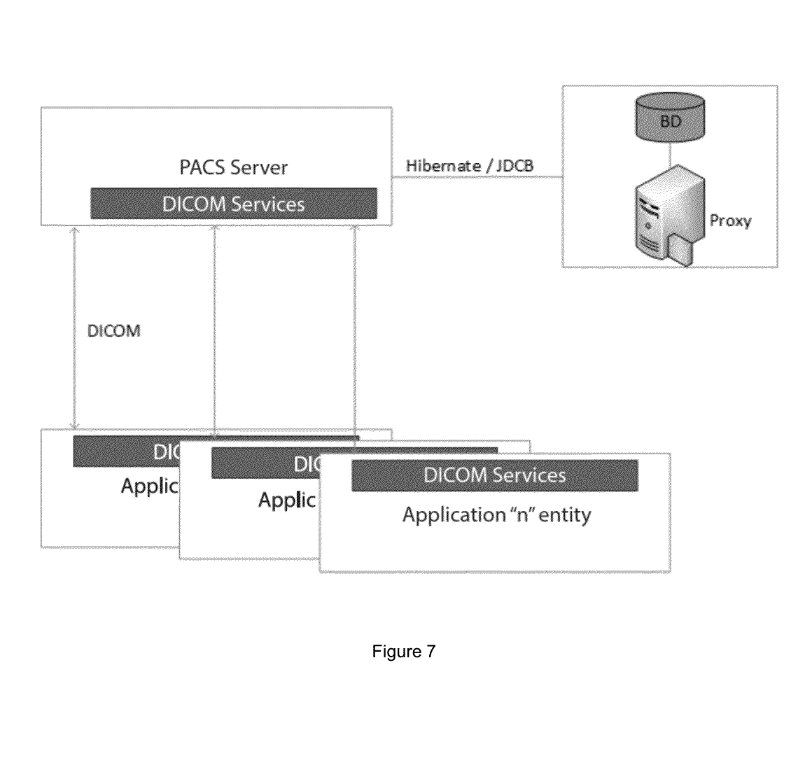

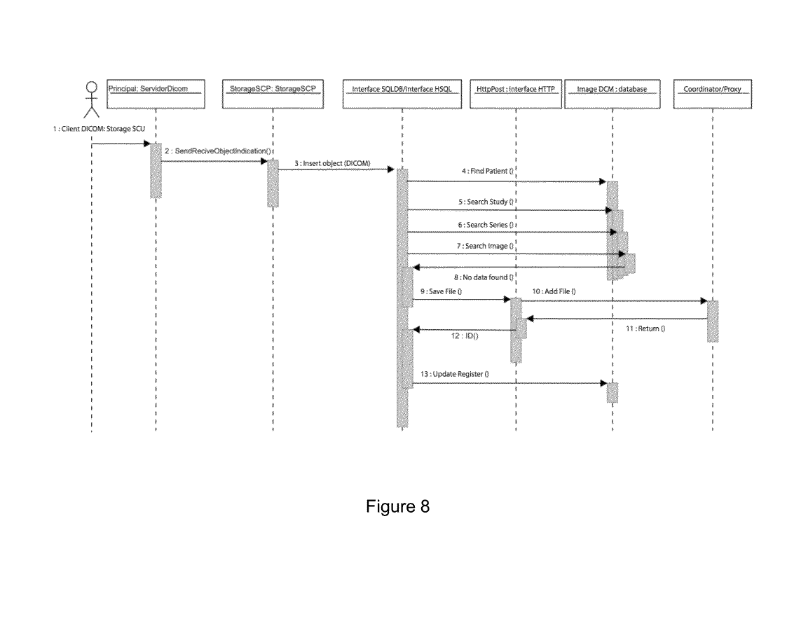

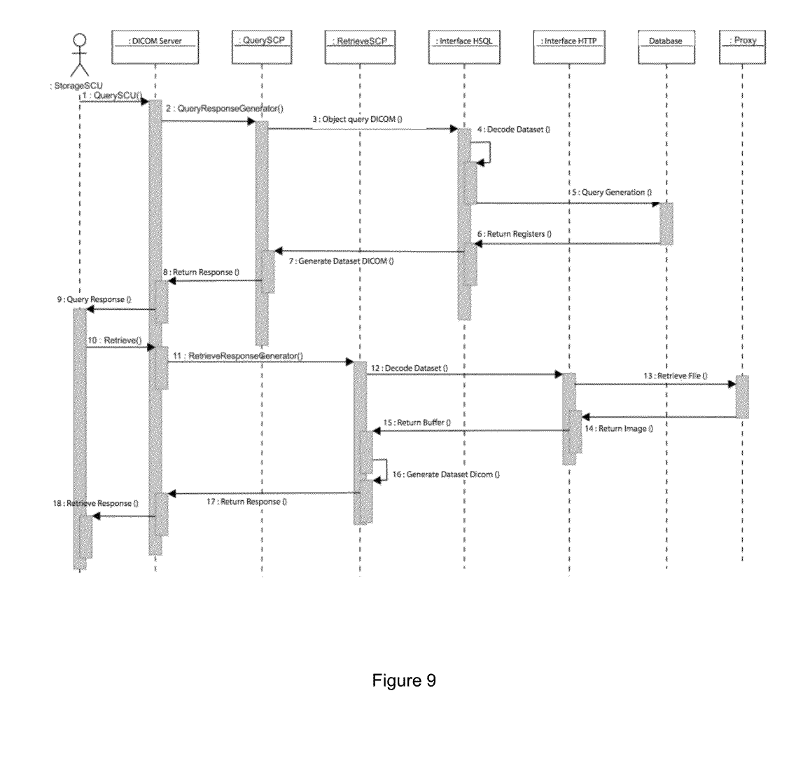

FIG. 3 depicts the timing diagram where the information storage process of the system in the present invention is described.

Stage b) comprises the following steps:

b1) An user communicates a coordinator or proxy with from the control module;

b2) The coordinator validates him as an authorized user;

b3) The user requests the stored information file, the coordinator consults its metadata in order to know the single identifier and the parameters used to store de file. Then he requests a node the recovery of the file with the single identifier. It is important to emphasize that a file generates one or more fragments, which in its turn generate the blocks; thereby the single stored data units are the blocks. From the metadata and the oracle, any node is able to recognize the final storage spaces of the blocks, then the recovery of the fragments, as well as the reassembly of the file may be commissioned to any node, looking for that to distribute the processing load in a balanced way;

b4) The node receiving the petition identifies the fragments it must recover and commissions them to a set of assigned nodes, which it assign taking care of maintaining the processing balance. On the other hand, each node receiving the petition to recover a fragment consults the metadata it receives to determine according to the storage parameters if the file was stored through simple replication or IDA, so it requests the blocks needed to those nodes in charge of their storing, invoking the oracle. This leads to the recovery of the fragment, which returns to the node requests it;

b5) By bringing together all the necessary fragments of the file, the node that received the original petition assembles the file and sends it to the coordinator or proxy, which in its turn routes it to the user. To improve efficiency in the answer to requests from the users, there is a set of spaces for the temporary storage called cache whose function is to store the most used files, cache is integrated into the control module of the cell.

Stage c) includes the following steps:

c1) The monitor supervises the status of the machines hosting the storage nodes. If it considers that one of the machines has fallen in a permanent fault, then it requires the system administrator to start the machine replacement;

c2) The administrator starts the replacement;

c3) With the help of its metadata, the proxy determines the blocks stored in the failing machine and requires the active nodes to start the replacement of each node stored in the failing machine. In its turn, each active node verifies in its support metadata the identity of the blocks corresponding to the fallen nodes. For each registered block that must be replaced it is necessary to recognize the treatment sequence of its origin, if the block corresponds to replication of a fragment, then it is enough to verify with the oracle in which other nodes are stored its other copies, meanwhile if the block was obtained by the information dispersal algorithm (IDA), it is necessary to recognize again through the oracle where the other dispersals are related to de missing one, in order to reconstruct the original fragment and then reconstruct the lost block from it;

c4) Once the lost blocks have been reconstructed, they are stored in the replacement machine;

c5) The emplacement or allocation of the blocks is associated to logical devices because these can be replaced without losing their identity, although their replacements host in new machines, this way metadata refers to logical entities, therefore it is not necessary to modify them in case of machines failure, however this decision forces the creation of an address resolution table, where the logical devices are translated to the specific addresses and ports where they temporarily host. When the blocks of the associated nodes have been replaced with the substituted machine, the proxy updates the address resolution table and notifies the return to operation of the recovered nodes.

In stage d) escalation or expansion of storage capacities, the system contains an initial set of disks that we will call the first era. When storage capacities have reached a limit, the administrator must start a stage to incorporate a new set of disks, that is the next era, and thus extend the available space. It is important to understand that all the steps applied to the cell nodes must be performed (ideally) immediately, which means that the system must not interrupt its operation. The aspects that must be taken care regarding the capacity scaling include: load balancing and metadata growth.

Stage d) comprises the following steps:

d1) The coordinator or proxy notifies that the disks forming the system get close to their storage capacity limit;

d2) The administrator connects a new set of disks that may be assigned to the machines already in operation or alternatively they are connected to the local network of new machines that include the disks. Care must be taken that two discs of the same era are not assigned to the same machine;

d3) The administrator releases in the address resolution table of the coordinator or proxy, data from the physical location and the logical node identifiers to be incorporated. From this moment, the new nodes can be used to store the new blocks to be generated;

d4) The administrator starts the function of load rebalancing after that the coordinator notifies all nodes to initiate load rebalancing, which consists in moving some of the previously stored blocks to take advantage of expanded capabilities that new nodes provide. Thereby, the nodes as far as are filled, invoke the oracle to determine whether to relocate the blocks they store. Meanwhile this function is not completed the coordinator keeps a copy of each block to be reallocated, both in its source and destination nodes. Finally, it erases the copies from the source node. At any time during the operation of the system it is important to ensure the fulfillment of blocks allocation requirement. It is important to note that this reallocation impacts metadata that manages the blocks, as well it is considered that the rebalancing may affect the performance of the services offered to users, thereby its implementation in unattended mode is suggested.

In a third mode, the system design principles of the present invention are based on that it can be designed to be constructed with some medium capacity devices and depending on storage needs it may grow to massive scales, however in massive scales a problem arises regarding services management, dependability, scalability and performance. To solve this serious problem a modular architecture is designed.

The service management of the system in the present invention is based on metadata, metadata appoints the information necessary for the management of services borne by the storage system, there are two types of metadata, the ones related to the user and the ones related to the files.

The users metadata are hosted in the proxies using a consensus protocol to maintain the consistency of databases. With regard to files metadata (or blocks metadata), these are stored in the nodes using a confident distributed storage protocol.

The system dependability requirement of the present invention is achieved by fault tolerance and the system availability, that there are two design principles for that guide the construction of fault tolerant storage systems: 1) the principle of information redundancy and 2) the principle of physical components redundancy.

The first principle ensures that the files stored in the system are processed to generate redundant information (either replicating it or using some type of error detector and corrector code, such as IDA), that files' availability increases from.

The second principle tells us that each redundant information unit or block, must be stored in independent spaces or devices (block allocation requirement) but furthermore tells us that there must be support devices, or reserves, which may come into operation in case of an active device falls into failure.

Regarding availability of the system, there are different ways to materialize this principle that relates to the continued operation of the system in charge. In a high performance system, for example, it is expected that of 10,000 hrs, the system will be out of service less than 1 h, resulting in an availability greater than 0.9999.

A key component accompanying the physical components redundancy is the monitor that has the responsibility to know the condition of “health” of the various components of the system and take measures for continuous operation (reset components notification to the superusers).

On the other hand, there are performance parameters that complement the specification of availability. Such is the case of recovery latency, this measure refers to the elapsed time from the moment an user requests a copy of a previously saved file to the time the last bit of his file is delivered.

Recovery latency performs a definitive role in the perception of the supported service quality. There are at least two strategies to limit latency: i) On the one hand, an upper bound is defined in the length of a data unit that can be stored, called maximum storage unit or MSU (other studies call it “chunk size”) and ii) The second strategy consists in designating a quick access space or cache, wherein the files required more frequently can be located.

The MSU allows to parallelize file storage and retrieval because it fragment it into smaller units that can be processed, stored and retrieved concurrently.

As for the cache, it is a storage space with limited capacity and very short access time, where the retrieved information is located, it is estimated, may be requested by a user or application, under heavy latency restrictions. This is the case of images and video servers, the cache can be used to store metadata too.

In order to meet the scalability requirements of the system of the present invention, the system must incorporate new storage devices, as their occupation is approaching a limit, however, the assimilation of new devices brings different problems to be envisaged. On one hand, metadata which stored information is managed with can grow to the point where its handling is inefficient. On the other hand, it is not enough to add a new storage device to retrieve the service quality of a system that is almost full. After admit a new device, the load stored until that moment must be rebalanced. Rebalancing not only involves moving data units (blocks) to other devices, which alone can be very expensive, but metadata used to locate blocks must be updated too. Accordingly, it is expected to move the minimum amount of information necessary to retrieve the performance of a system. Facing these problems it is said that the oracle or consultation mechanism used to locate or relocate charge must fulfill the following properties:

Be efficient in capacity and promote justice; the first means that it must use the maximum storage capacities of each device, meanwhile, the latter means it should spread the load according to available capacities, that is, the largest device is assigned with more load than the small one device.

Be efficient in time, which means that the time must be minimum to determine the location of a data unit or the site where a processing operation must be performed.

Be compact, which means that metadata needed to determine the location of a data unit must be small, it is to note that this property may be in conflict with the foregoing.

Be adaptable, which means that it must to be adapted to the capacities growth.

At the same time, it is very important too to consider the redundancy management or the so called stretch factor, the latter term refers to the redundant information originated by a file, for example, redundancy is born by a duplication technique, then a file is taken and two copies are generated, whereby a stretch factor of 3 is achieved, if in contrast, we use an information redundancy procedure by an encoding technique, such as IDA, then the original file is converted into n files, such that m of them are enough to recover the original, in this case one speaks of a stretch factor of n/m.

In any circumstance, it must be avoided at all costs that any two data units or objects with a common origin remains stored in the same device because it engages the fault tolerance of the storage system. This last requirement is often described in probability theory as the bins and balls problem. Balls refer to blocks that result from a process generating redundant information and bins refer to storage devices. We will call redundant set the set of balls with a common origin.

Under no circumstances we want two balls from a redundant set, to be assigned to the same bin, this condition is called the block allocation requirement.

We consider the requirements of modularity and interoperability of the system of the present invention, as it is known that the functions bearing the system of the present invention may evolve over time, we understood that modularity is a fundamental design requirement. The resulting solution is a weakly coupled set of modules that can be modified each separately, so we can replace any of these and even change the communication mechanisms with external entities thereby reinforce the interoperability of the system, the system offers a dingle interface too, supervised by the coordinator, thereby any type of applications obeying the small set of primitives of service recognized by the coordinator itself may be connected.

FIG. 4 corresponds to the class diagram, where the entities integrating the objects of the architecture of the present invention are observed, for example, the node, the coordinator and the monitor.

The functionality of each object is described as follows:

Proxy or coordinator: in charge to receive the service requests from the clients and the administrator, as well as to coordinate the nodes participating in the processes bearing the requested services. It has the following duties:

Configuration and control: It stores the storage cell configuration and performs the control processes involving the storage nodes.

Access control: It has the responsibility to allow or deny the access to files according to the cell configuration and the clients.

Consulting engine: It bears a set of consulting operations to store, recover and look for files. Thereby it manages the metadata related to the files stored in the cell.

Load balance: It allows to distribute the load in a right way between the nodes.

Synchronization engine: It allows the coherent existence of various coordinators replicating metadata among this set.

Storage node: Subsystem in charge of receiving petitions from the coordinator and other nodes, as well as to request data or assign work to other nodes.

Processing: It processes the information treatment requests, such as fragmentation, replication, IDA, integrity verification, load balance, among others.

Storage: It manages the physical device where data are stored and assures storage independently of the manufacture technology or the underlying file system.

Monitor: In charge to supervise the condition of the other components, in order to sponsor the continuity of the system operations. Among the actions it can run to this end, there is to restart some subsystems, as well as the notification of incidents to the administrator.

Technical Characteristics of Hardware and Software of the Modules of the System of the Present Invention

i) Control module or proxy
Based on CentOS 6.3 installed on an HP Proliant
ML110 G7
Processor Intel Xeon 3.1 GHz
RAM: 14 GB 1333 MHz
Hard Drive: 250 GB x² VB0250EAVER HP, Western
Digital WDC-008 2 TB WD20EARX
Services: Web server (Apache, MySQL, PostgreSQL, PHP, PHP-admin,) Website of the system of the present invention called Babel (based on Joomla), Babel File System (Oracle Java, Python)

ii) Storage module
5 storage machines based on CentOS 6.3 installed on computers MSI MS-7592, the number of nodes may vary depending on the amount of information to be treated.
Processor: Intel Pentium D 2.70 GHz E5400
RAM: 2 GB 1333 MHz
Hard Drive: 500 GB SeaGate
Services: Web (Apache, MySQL, PostgreSQL, PHP, PHP-admin), Babel File System (Oracle Java, Python)

iii) Communications module
A Switch HP V1410-24-2G
24 ports 10/100Base TX
2 ports 120/100/1000Base T

iv) Cell monitor
Based on openSUSE 12.2 mounted on an HP Proliant
ML110 G7
Processor: Intel Core 2 Quad Q8400 2.66 GHz
RAM: 4 GB 1333 MHz
Hard drive: x² Seagate ST500DM002 500 GB, Seagate
ST3320620AS 320 GB

v) Security module or Firewall
Based on FreeBSD 8.1 RELEASE-p6 mounted on a computer ACER VERITON M22610
Processor: Intel Pentium D 2.8 GHz
RAM: 2 GB 1333 MHz
Hard Drive: SeaGate 160 GB
With two additional network cards Intellinet Gigabit PCI Network Card 522328y SatarTech PEX100S
Services: border Firewall (port filtering and NAT), Management via SSH, OpenVPN based tunnel.

### Advantages

The system of the present invention is based on a model or a set of general storage principles that can be applied regardless of the technology it is installed on.

The system of the present invention recognizes the importance to fragment the information before it is processed and stored, however the system allows to shape the fragment size or the maximum storage unit (MSU) as a function of the application. This means that for a particular instance the fragment can be shaped to 0.5 MB meanwhile for an other instance, it may assume a 500 MB value.

Its design allows to incorporate new functions for the information treatment, so that each function offers an interface behind to the algorithms implementing them may be changed, depending on the status of the technique. In this sense, the design may be understood as a general model for the processing and storing of information.

Its design allows that after fragmentation, an arbitrary sequence of treatment steps such as managing integrity, confidentiality and compression. In the current version, these are implemented: a fragmentation function, two algorithms for generating redundant information (own version of the IDA and a replication algorithm that produces 3 instances of each original fragment, but this number is configurable too), a function for generation and verification of integrity and a function for load balancing, called oracle.

The communication module allows the protocols used within and outside of the storage cell may be configurable and adaptable to different applications. In its current version the WCF and HTTP protocols are born.

Each node is a logical device that hosts on a storage module machine, this has storage capacity managed by the node, the machine is connected to the coordinators or proxies through the communications module (switch) forming a local network, and may host one or more nodes depending on the amount of information to be stored. The network is supported with a switch that can connect up to 36 machines, each machine has a 500 MB disk, and can host two more disks, in this sense the node can be understood as a “storage virtual box”, it is important to emphasize that each storage operation is based on local resources of the device involved, this means that the operation is performed regardless of the underlying storage technology or the local file system that manages it, which allows to integrate different operating systems (for example, Linux, MacOS, Windows and/or Unix) and storage technologies (for example, SATA, NAS and/or SAS), through a standardized interface born by the coordinators or proxies.

The system of the present invention uses a cache memory, located in the proxies, to accelerate the recovery of files that are used frequently.

The system of the present invention may be managed by one or more proxies, the number depends on the application and the incoming traffic that may be received by the service requests but may range from 1 to 5 approximately.

The oracle is another very important function of the system of the present invention, it may be implemented with different algorithms that bear the same function, furthermore the oracle is implemented as a dispersing hash function, which receives the identifier of a data unit to be processed or stored and in response returns the identifier of the node to which this duty may be commissioned. This property guarantees a minimum size of metadata that must be registered, as well as a balance in the processing load and storage.

### EXAMPLES

The following examples are intended to illustrate the invention and not to limit it, any change from the experts in the art, falls within the extent of same.

### Example 1

The following example describes the construction of a prototype of the system for the treatment and storage of data, based on low-cost components, that guarantee the integrity and availability of data, and the ability to manage them by the same organizations where they are applied. This prototype is called SAD and the components it includes are:

i) Control module or proxy
Based on CentOS 6.3 installed on an HP Proliant
ML110 G7
Processor Intel Xeon 3.1 GHz
RAM: 14 GB 1333 MHz
Hard Drive: 250 GB x² VB0250EAVER HP, Western Digital WDC-008 2 TB WD20EARX
Services: Web server (Apache, MySQL, PostgreSQL, PHP, PHP-admin,) Website of the system of the present invention called Babel (based on Joomla), Babel File System (Oracle Java, Python)

ii) Storage module
5 storage machines based on CentOS 6.3 installed on computers MSI MS-7592, the number of nodes may vary depending on the amount of information to be treated.
Processor: Intel Pentium D 2.70 GHz E5400
RAM: 2 GB 1333 MHz
Hard Drive: 500 GB SeaGate
Services: Web (Apache, MySQL, PostgreSQL, PHP, PHP-admin), Babel File System (Oracle Java, Python)

iii) Communications module
A Switch HP V1410-24-2G
24 ports 10/100Base TX
2 ports 120/100/1000Base T

iv) Cell monitor
Based on openSUSE 12.2 mounted on an HP Proliant
ML110 G7
Processor: Intel Core 2 Quad Q8400 2.66 GHz
RAM: 4 GB 1333 MHz
Hard drive: x² Seagate ST500DM002 500 GB, Seagate ST3320620AS 320 GB

v) Security module or Firewall
Based on FreeBSD 8.1 RELEASE-p6 mounted on a computer ACER VERITON M22610
Processor: Intel Pentium D 2.8 GHz
RAM: 2 GB 1333 MHz
Hard Drive: SeaGate 160 GB
With two additional network cards Intellinet Gigabit PCI Network Card 522328y SatarTech PEX100S
Services: border Firewall (port filtering and NAT), Management via SSH, OpenVPN based tunnel.

With this prototype the following processes are supported:
a) Storing a file,
b) Recovery of a file,
c) Replacing a failing machine, and
d) Scaling of storage capacities.

This gives excellent results in the storage and retrieval of information in this system SAD, which allows processing and storage of data based on low-cost components, that guarantee integrity and availability of data, and the ability to manage it.

### Example 2

The following example is a description of the construction of a prototype for implementation of a corporate memory that uses the system of the present invention, this prototype is based on the cloud model.

The problems brought about by the growth of information are accentuated as a consequence of regulations establishing long periods of time during which this information must be preserved.

In these conditions the following challenges are presented in the storage systems:
To avoid the disruption of service due to saturation or failures.
To guarantee the availability of information.
To control the access to sensitive information.

Cloud storage is a service model available online, thereby information is stored on multiple servers, usually managed in a unified way. Providers of this service virtualize resources according to their clients needs and present them as private “devices” that can adapt to their needs. These devices can be accessed via services applications interfaces.

Cloud storage is an emerging technology proposed to take advantage of existing Internet infrastructure and offer high computing allowances at low cost, meanwhile the control and management of distributed resources is centralized by the use of virtualization systems. Thereby it is expected to address the above challenges and improve organizations competitiveness. It should not think of cloud storage just as a service provided by a third party. Rather than to be a business model, it is a new beginning for the resources management.

It is possible for an organization to construct and operate its own private cloud, thereby to offer services to their staff. In this way, information availability and integrity problems may be solved, controlling the infrastructure thereby this service is supported without compromising confidentiality of sensitive data, preventing them from leaving “home” and be managed by third parties.

In the other hand, knowledge management in an organization allows to achieve the objectives of the community with effectiveness and economy of resources. The corporate memory is a mechanism for managing knowledge developed within an organization in order to optimize its transfer between those producing it and those that may benefit from it. The corporate memory, also called group memory or corporation memory, is the combination of a deposit, wherein objects and artifacts are stored, where people can interact with these objects to learn and make decisions.

Based on the flexibility offered by the system of the present invention with respect to storage, and the growing need for storage in organizations, an application of the storage cell was developed. This application uses an Http/Https server (Apache, IIS, Web2Py) thereby a service able to connect to the storage cell and in the end-user side is constructed, it offers a web page where the stored information can be consulted.

The application architecture construction of the corporate memory is described in FIG. 5 and here we will describe the main parts:

Storage cell: Represents the set of nodes connected via a local network.

Communication layer: This component is responsible for communicating with the storage cell to add or retrieve files and present them in a format that can be recognized by the Web server. This component is divided into the following parts:

Communication: It is responsible for converting requests made through the Web into requests that the cell can understand and process.

Control: It makes the pursue of requests and routes them to the communication layer for processing, receives the results of the communication layer too and delivers them to the presentation layer.

Presentation: It is in charge to provide an user interface compatible with the web server. This interface allows users to search, add, delete, and retrieve the files thereby the user has access.

Web Server: This component is not developed by us, we can use standard servers developed by the industry as Apache or IIS. Its main function is to provide web browsers the access to the communication layer with the cell.

Process of operation: The application of corporate memory gives users the ability to add, delete, recover and search for files they may access, using a web interface that guides every step of each process.

Adding a file:
The User that is in the web interface visualizing the files he has stored in the cell, there is a button with the text “Add File”.
The user clicks on the button “Add file”.
The system shows a selection table of the file it is desirous to add.
The user selects the file.
The system communicates with the cell to store the file.
The user is notified that its file has been added.

Deleting a file:
User is in the web interface visualizing the files he has stored in the cell.
User chooses the file to delete by ticking it and presses the button with the text “Delete file”.
The system shows a delete confirmation table.
User confirms the file deletion.
The system communicates with the cell to delete the file.
User is notified that the file has been deleted.

Recovering a file:
User is in the web interface showing the files he has stored in the cell.
User chooses the file to recover by visualizing it and presses the button with the text “Retrieve file”
The system shows a table asking for the folder to download the file.
User provides the information requested.
The system communicates with the cell to recover the file.
User is notified that the file has been downloaded.

Looking for a file:
User is in the web interface visualizing the files he has stored in the cell.
User chooses the option “Looking for a File”.
The system shows a table requesting the file name being searched or some characters that compose it. It accepts wildcard characters too.
User provides the information requested.
The system communicates with the cell to make an inquiry.
The system shows the user search results. If it is found, the user is notified and in other case, it notifies the user that the file is not stored.

The application based on the proposed architecture allows institutions and companies to profit the advantages of the storage cell, such as high dependability, performance and scalability, ensuring at the same time the availability and integrity of data for its own administration.

### Example 3

The following example describes the construction of a prototype for communication and storage of medical images files PACS (Picture Archiving and Communications Systems) for its application in clinics, health centers, hospitals, institutes, etc., which uses the system of the present invention.

To meet the health needs of a population, it is required that all health services (clinics, health centers, hospitals, institutes) have the best tools to facilitate the suitable care of the problems.

In this stage, medical imaging is considered fundamental for the appraisal, diagnosis, treatment and monitoring of diseases. It is known that there is a mature technology that can meet this need. However, in its current status it is very expensive which limits its application. An imaging system requires a storage component to manage storage of massive volumes of information.

A PACS system is a central component in the imaging area of a clinic or hospital. It is an alternative for managing large volumes of medical images in digital format. Its main function is to coordinate the operation of acquisition apparatus (X-rays, MRI, IVUS, OCT, CT scan, etc.) and of display or visualization terminals (whether they be diagnostic or consult), having as their operating base, or core, a communications network and a set of software applications that obey the standard DICOM (Digital Imaging and Communications in Medicine) to ensure compatibility between heterogeneous components.

From a design point of view it is fundamental that a PACS considers scalability, security and availability requirements; it must be fault tolerant and furthermore to be an open architecture that allows the replacement of components from different manufacturers.

A PACS is a system that requires a storage component with strong scalability and availability restrictions. In order to evaluate the prototype of this example it has been developed a minimum set of standard services that must be validated according to certain fulfilling tests set by the DICOM standard. Initially it is considered to operate a first version, using a set of free software libraries, called “pixelmed”, which will be replaced by our own versions.

The proposed architecture to communicate a PACS storage system with the module or storage cell of the system of the present invention is shown in FIG. 7.

The storage server must contain a database to store information related to DICOM information objects (IOD), it must provide at least DICOM services such as storage (StorageSCP), query (QuerySCP), retrieval (RetrieveSCP) and verification (EchoSCP) to bear the exchange of information with the applications called application entities AET's (DICOMClient).

The storage server prototype is divided into the following layers:
DICOM communication layer: This layer contains the pixelmed libraries to bear the standard communication between application entities.
DICOM Services layer: This layer inherits the functionality of the communication layer and implements the functionality to communicate with the module or storage cell via HTTP communication protocol (HTTP interface), it implements an interface too (HSQL interface) to bear the storage to a database via SQL.
Storage Layer: This layer bears the database standard scheme for a DICOM database with a structure to recover information from patient data, study, series and image. Importantly, the unique identifiers of the stored files are also recorded in the cell.

The exchange of information between the storage cell and the application entity providing storage service is done in 2 steps, as described in FIG. 8; the sequence diagram to store a DICOM information object in the module or storage cell of the present invention.

Step 1: Information objects storage.

1a) When a client application entity (DICOMClient) requests the storage server to store an information object DICOM IOD, this receives it (through the DICOM storage services), extracts all the important parameters (dataset) of the information object and writes them in a database with the structure of a patient, which contains studies, meanwhile a study contains series, and the series contains images; it subsequently communicates through the http interface with the proxy or coordinator of the storage cell using the HTTP protocol requesting to store the IOD in the cell.

1b) If storage in the cell is successful, the proxy returns the single identifier corresponding to the IOD.

1c) The storage server updates in the DICOM database (image table) the name of the identifier corresponding to the IOD sent to the cell.

FIG. 9 describes the sequence diagram to make query and retrieval of information objects DICOM.

Step 2: Consultation and retrieval of information objects in terms of image.

2a) When a client application entity (DICOMClient) requests to retrieve an information object, the request includes a set of attributes that must be interpreted and decoded by the PACS server to perform the query in the database and extract the unique identifiers of the information objects (the level of consultation to extract data from the storage cell should be from image).

2b) With the single identifier the file retrieval request is made to the storage cell.

2c) The information object is returned through DICOM retrieval service to the client who requests it.

The application based on the proposed architecture allows health institutions such as clinics, health centres, hospitals, schools, etc., to profit the advantages of the storage cell, such as high dependability, performance and scalability, that guarantee integrity and availability of data for its own administration.

The expert is well aware of the process in the art for manufacturing the modules, networks and prototypes that integrate the system of the present invention, so it is not necessary to mention them in detail.

1-35. (canceled)

36. A high performance system and method for data processing and storage, based on low cost components, which ensures the integrity and availability of the data for the administration of same comprising the following modules:
i) A control module in charge of one or more coordinators or proxies, where each proxy manages and coordinates the operation of the storage nodes and answers to service requests from clients, and bears different application interfaces that guarantee the system interoperability;
ii) A communications module that interconnects the different modules of the system, and is in charge of a data switch, where the number of devices the switch can communicate varies from 6 to 32; further characterized by
iii) A storage module that consists of a set of machines, each machine can hold one or more storage nodes, where fragmentation, replication, the information dispersal algorithm (IDA), generation, integrity sequence verification, the oracle and data storage are carried out,
wherein fragmentation is a function that divides a file into smaller data units called fragments, adding to each of these the information needed to perform the reverse operation, that is reassembly of the original file,
wherein replication is a function that receives the fragment and produces multiple copies of it, called blocks, the number of blocks is related to the amount of redundant information thereby integrity of the fragment is guaranteed, in case of damage to the original data,
wherein the information dispersal algorithm (IDA) transforms a fragment into n data units called dispersals or blocks, such that any m of them are enough to reconstruct the original unit, evidently n>m>1, the algorithm involves the dispersion function and reconstruction function, the relation between n and m parameters is very important to define the amount of redundant information and fault tolerance, when m is close to n, then the algorithm tolerates few loss, but requires few redundant information too, when m is close to 1, the algorithm bears a greater number of losses, but produces a very large amount of redundant information, n must be greater or equal to 3,
wherein the generation and verification of the integrity sequence is a function to detect corruption of the stored blocks, an algebraic information process is performed to generate a sequence of bits which are concatenated with the original information, after it has been stored or transmitted a similar process can be used to compare the resulting verification accompanying the data, if these do not coincide it is said that the data has been corrupted, in which case the data unit should be rejected, in implementation the integrity verification process of the blocks is performed by the cyclic redundancy code CRC-32 defined by ITU-T,
wherein the oracle has the object to guarantee the process load balance and information storage, moreover it is implemented as a hash function, that receives the data unit identifier to be processed or stored and answering it returns the identifier of the node to which this duty may be commissioned, the oracle guarantees that each of the blocks coming from the same fragment are stored in nodes that hosts on different machines (independent) so that it meets the blocks allocation requirement, the oracle is a function that is implemented and invoked in each storage node and each proxy, and
wherein data storage is carried out by storing a file, file recovery, substitution of a failing machine and escalation or expansion of storage capacities;
iv) A security module or firewall is hardware and software module that is transparent to the application client, it validates access to each proxy to prevent malicious users may damage it, when a user connects to the website where the system's public address or storage cell is, apparently the user connects to the proxy, but the user does not know that before communicating with it, the firewall checks its communication and authorizes its access to the proxy; and
v) A monitor module that is after the firewall module and is responsible to supervise the operations taking place in each proxy and storage node, physically it can be on the same machine as the proxy or in a machine connected to the cell by the same switch that connects all other components.

37. The high-performance system for the treatment and storage of data in accordance with claim 36, characterized by the control module that is in charge of one or more coordinators or proxies, each proxy manages and coordinates the operation of the storage nodes and answers the service requests from clients, such as storing and retrieving files.

38. The high-performance system for the treatment and storage of data in accordance with claim 36, characterized by each proxy that bears different application interfaces to guarantee the system interoperability and the number of proxies depends on the application and the incoming traffic that can be received from the service requests, its number can vary from 1 to 5.

39. The high-performance system for the treatment and storage of data in accordance with claim 36, characterized by the modules of the system that are interconnected via the communications module, by a data switch that can be implemented with different technologies, including twisted pair, coaxial cable and optical fiber.

40. The high-performance system for the treatment and storage of data in accordance with claim 36, characterized by the storage module formed by a set of machines equipped with storage capacity connected by the data switch, forming a local network, each machine has a 500 MB disk and can host two more disks.

41. The high-performance system for the treatment and storage of data in accordance with claim 36, characterized by each machine that can host one or more nodes, each node is a logical device and can be understood as a storing “virtual box”, storage operations are based on local resources of each node involved and the operation is performed regardless of the underlying storage technology or the local file system that manages it, this allows the integration of different operating systems such as Linux, MacOS, Windows and/or Unix and storage technologies such as SATA, NAS and/or SAS.

42. The high-performance system for the treatment and storage of data in accordance with claim 36, characterized by the number of machines forming the storage module, that can range from 1 to 32, connected by the communications module and forming a local network.

43. The high-performance system for the treatment and storage of data in accordance with claim 36, characterized by the storage module that has a configurable parameter called maximum storage unit (MSU) that may vary from 0.5 MB up to 500 MB, which improves processing balance and storing. When the selected node starts receiving a file to be stored, it is divided into as many fragments as necessary to guarantee that the length of each fragment does not exceed the given MSU.

44. The high-performance system for the treatment and storage of data in accordance with claim 36, characterized by each proxy that is part of the control module, which can be based on CentOS 6.3, installed on an HP Proliant ML110 G7, with an Intel Xeon 3.1 GHz Processor, 14 GB 1333 MHz RAM, Hard Drive: 250 GB x² VB0250EAVER HP, Western Digital WDC-008 2 TB WD20EARX.

45. The high-performance system for the treatment and storage of data in accordance with claim 36, characterized by
each machine of the storage module that can be based on operating system CentOS 6.3 installed on computers MSI MS-7592, with an Intel Pentium D E5400 2.70 GHz processor, RAM: 2 GB 1333 MHz and Hard Drive: 500 GB SeaGate.

46. The high-performance system for the treatment and storage of data in accordance with claim 36, characterized by the communications module that can be implemented with a Switch HP V1410-24-2G, with 24 ports 10/100Base TX and 2 ports 120/100/1000Base T.

47. The high-performance system for the treatment and storage of data in accordance with claim 36, characterized by the firewall that can be based in operating system FreeBSD 8.1 RELEASE-p6, mounted on a computer ACER VERITON M22610 with Processor: Intel Pentium D 2.8 GHz, RAM: 2 GB 1333 MHz, Hard Drive: SeaGate 160 GB, with two additional network cards Intellinet Gigabit PCI Network Card 522328y SatarTech PEX100S and services: border Firewall (port filtering and NAT), Management via SSH, OpenVPN based tunnel.

48. The high-performance system for the treatment and storage of data in accordance with claim 36, characterized by the monitor based on operating system openSUSE 12.2 mounted on an HP Proliant ML110 G7, Processor: Intel Core 2 Quad Q8400 2.66 GHz, RAM: 4 GB 1333 MHz, Hard drive: x² Seagate ST500DM002 500 GB, Seagate ST3320620AS 320 GB.

49. A high-performance process for the treatment and storage of data, based on low-cost components that guarantee the integrity and availability of data for its own administration, which comprises the following stages:
i) Fragmentation, a function that divides one file into smaller data units, called fragments, and adds to each of them the information needed to perform the reverse operation, that is, the reassembly of the original file, fragmentation is a function implemented and invoked in each storage node.
ii) Replication, a function that receives a fragment and produces multiple copies of it, called blocks, the number of blocks is a function parameter related to the amount of redundant information that seeks to guarantee the integrity of the fragment, in case of damage to the original data. This function is implemented and invoked from any of the storage nodes; also characterized by
iii) Information dispersal algorithm (IDA), which turns a fragment into n data units called dispersals or blocks, such that any m of them are enough to reconstruct the original unit, evidently n>m>1, the algorithm involves the dispersion and reconstruction functions, the relation between parameters n and m plays an important role in defining the amount of redundant information and fault tolerance, when m is close to n, then the algorithm tolerates few losses, but also requires little redundant information, when m is close to 1, the algorithm supports a greater number of losses, but produces a very large amount of redundant information, and also n has to be greater or equal to 3.
iv) Generation and verification of integrity sequence, which is a mechanism to detect corruption of the stored blocks, an algebraic processing of information is performed to generate a sequence of bits that are concatenated with the original information, after it has been stored or transmitted, a similar process may be used to compare the resulting sequence of verification accompanying the data, if these do not match, it is said that data has been corrupted, in which case the data unit must be discarded, where implementation of the verification procedure of the blocks integrity is performed by the cyclic redundancy code CRC-32 defined by the ITU-T;
v) The Oracle, its goal is to guarantee the processing load balance and information storage, moreover the oracle is implemented as a dispersing hash function, that receives the identifier of a data unit to be processed or stored and answers returning the identifier of the node to which this duty can be commissioned, the oracle guarantees that each of the blocks coming from the same fragment is stored in nodes residing in different machines (independent), so that the blocks allocation requirement is achieved. The oracle must ensure the blocks allocation requirement, the oracle is a function implemented and invoked in each storage node and proxy; and
vi) Data Storage that is carried out by a) storing a file, b) recovering a file, c) replacing a failing machine, and d) scaling or expansion of storage capacities.

50. The high-performance process for the treatment and storage of data in accordance with claim 49, characterized by stage iii′) which requires the implementation of a finite field GF (2³) generated from the primitive polynomial g(x)=x⁸+x⁶+x⁵+x⁴+1, also uses a scattering matrix of n rows by m columns, such as a scattering matrix of 5 rows by 3 columns as the one shown below.
$$\begin{matrix}1 & 3 & 2 \\ 1 & 1 & 1 \\ 2 & 3 & 1 \\ 2 & 2 & 3 \\ 2 & 3 & 3\end{matrix}$$
wherein the information dispersal algorithm or IDA is a function implemented and invoked in each storage node.

51. The high-performance process for the treatment and storage of data in accordance with claim 49, characterized by the verification procedure of the blocks integrity that is performed by the cyclic redundancy code CRC-32 defined by the ITU-T, this function is implemented and can be invoked from each storage node.

52. The high-performance process for the treatment and storage of data in accordance with claim 49, characterized by the oracle that guarantees that each of the blocks coming from the same fragment is stored in nodes residing in different machines (independent) we call this condition “blocks allocation requirement”, the oracle must guarantee the blocks allocation requirement, moreover the oracle is a function implemented and invoked in each proxy and storage node.

53. The high-performance process for the treatment and storage of data in accordance with claim 49, characterized by the stage a) that comprises the following steps:
a1) A user contacts a proxy from the control module;
a2) The proxy validates him as an authorized user;
a3) As the user submits his file with the information, the coordinator assigns him a single identifier and then creates a data stream between his computer and a storage node, the node selection is decided invoking the oracle, which ensures processing load balance and information location, the coordinator records this operation in a local database called metadata, in order to bear the future retrieval of the information it receives;
a4) The storage module has a configurable parameter called maximum storage unit (MSU), to improve processing balance and storing. When the selected node starts receiving data stream, it divides into as many fragments as necessary to guarantee that the length of each fragment does not exceed the given MSU, each fragment's size may vary between 0.5 MB up to 500 MB;
a5) After fragmenting the file it receives, the node in charge invokes the oracle again to assign the processing of new data units (fragments) to the other nodes involved in the storage cell;
a6) Each node receiving a fragment may subject it to a series of processing stages that depend on the profile of the user requesting the service, in any case, we will refer as blocks to data units resulting from this stage, the system supports two alternative treatments: replication or the information dispersal algorithm (IDA). Depending on the service level agreed with each user, the node receiving a fragment selects one of these, Replication creates n identical copies of the fragment, this is a variable parameter, but it has a default value equal to 3, instead, dispersal creates a set of n different bits chains, also called blocks, such that any m of them are enough to reconstruct the original unit, it is important to emphasize that both functions parameters are configurable, in the case of IDA, the only condition is that 1<m<n, for example, in an IDA implementation we can have the values m=3 and n=5;
a7) For each resulting block an integrity verification function is invoked, using a cyclic redundancy code (CRC ITU-T of 32 bits), the resulting chain concatenates at the end of each block and serves to control—when it is recovered—that the block has not been damaged, after this last treatment the blocks are stored in the system's nodes invoking the oracle again, it is very important to ensure that each of the blocks coming from the same fragment is stored in nodes residing in different machines, we call this condition “blocks allocation requirement”, apart from storing the blocks, each node generates local metadata that are stored in the same node and in an additional node (determined by the oracle) for its support; and
a8) The node designated to process or store an information unit (file, fragment or block) confirms to the immediate source from which it has received the duty, when it has completed it.

54. The high-performance process for the treatment and storage of data in accordance with claim 49, characterized by the stage b) that comprises the following steps:
b1) An user who contacts a coordinator or proxy from the control module;
b2) The coordinator validates him as an authorized user;
b3) The user requests the stored information file, the coordinator consults its metadata in order to know the single identifier and the parameters used to store the file, then he requests a node to recover the file with the single identifier, it is important to emphasize that a file generates one or more fragments, which in its turn generates the blocks; thereby the single data units that are stored are the blocks, from the metadata and the oracle, any node is able to recognize the final storage spaces of the blocks, then the recovery of the fragments, as well as the reassembly of the file may be commissioned to any node, looking to distribute the processing load in a balanced way;
b4) The node receiving the petition identifies the fragments to be recovered and commissions them to a set of assigned nodes, taking care to maintain the processing balance on the other hand, each node receiving the petition to recover a fragment, consults the metadata it receives to determine according to the storage parameters if the file was stored through simple replication or IDA, so it requests the blocks needed to those nodes in charge of their storing, invoking the oracle, this leads to the recovery of the fragment, which returns to the node that requested it, in the case of IDA, the node must receive at least m blocks with which it invokes the reverse procedure to recover the requested fragment, in the case of simple replication, it is enough to recover a block that is a simple replication of the fragment that was requested;
b5) By bringing together all the necessary fragments of the file, the node that received the original petition assembles the file and sends it to the coordinator or proxy, which in turn routes it to the user, to improve efficiency answering the requests from users, there is a set of temporary storage allocations called cache whose function is to store the most frequently used files, cache is integrated into the control module of the cell.

55. The high-performance process for the treatment and storage of data in accordance with claim 49, characterized by the stage c) that comprises the following steps:
c1) The monitor supervises the status of the machines hosting the storage nodes, if it considers that one of the machines is permanently failing, then it requires the system administrator to start the machine replacement;
c2) The administrator starts the replacement;
c3) With the help of its metadata, the proxy determines the blocks stored in the failing machine and requires the active nodes to start the replacement of each node stored in the failing machine. In its turn, each active node verifies in its support metadata the identity of the blocks corresponding to the fallen nodes. For each registered block that must be replaced it is necessary to recognize the treatment sequence of its origin, if the block corresponds to replication of a fragment, then it is enough to verify with the oracle in which other nodes are stored its other copies, meanwhile if the block was obtained by the information dispersal algorithm (IDA), it is necessary to recognize again through the oracle where the other dispersals related to the missing one are, in order to reconstruct the original fragment and then reconstruct the lost block from it;
c4) Once the lost blocks have been reconstructed, they are stored in the replacement machine;
c5) The emplacement or allocation of the blocks is associated to logical devices because these can be replaced without losing their identity, even that their replacements host in new machines, in this way metadata refer to logical entities, therefore it is not necessary to modify them in case of machines failure, however this decision compels the creation of an address resolution table, where the logical devices are translated to the specific addresses and ports where they temporarily host, when the blocks of the associated nodes have been replaced with the substituted machine, the proxy updates the address resolution table and notifies the return to operation of the recovered nodes.

56. The high-performance process for the treatment and storage of data in accordance with claim 49, characterized by the stage d) wherein it is considered that the system contains an initial set of disks that we will call the first era, when storage capacities have reached a limit, the administrator must start a stage to incorporate a new set of disks, that is the next era, and thus extend the available space, it is important to understand that all the steps applied to the cell nodes must be performed (ideally) immediately, which means that the system must not interrupt its operation, the aspects that must be taken care of regarding capacity scaling include: load balancing and metadata growth.

57. The high-performance process for the treatment and storage of data in accordance with claim 49, characterized by the stage d) that comprises the following steps:
d1) The coordinator or proxy notifies that the discs forming the system get close to their capacity limit;
d2) The administrator connects a new set of discs that may be assigned to the machines already in operation or alternatively they are connected to the local network of new machines that include the disks. It must to take care that two disks of the same era are not assigned to the same machine;
d3) The administrator releases in the address resolution table of the coordinator or proxy, data from the physical location and the logical node identifiers to be incorporated, from this moment, the new nodes can be used to store the new blocks to be generated;
d4) The administrator starts the function of load rebalancing after which the coordinator notifies all nodes to initiate load rebalancing, which consists in moving some of the previously stored blocks to take advantage of expanded capabilities that new nodes provide, to this end, the nodes until now filled, invoke the oracle to determine whether to relocate the blocks they store, until this function is completed, the coordinator keeps a copy of each block to be reallocated, both in its source and destination nodes, finally it erases the copies from the source node. At any time during the operation of the system it is important to guarantee the fulfillment of “blocks allocation requirement”, it is important to note that this reallocation impacts metadata that manages the blocks, it also is estimated that rebalancing can affect the performance of the services offered to users, therefore its implementation in unattended mode is suggested.

58. The high-performance process for the treatment and storage of data in accordance with claim 49, characterized by each node of the storage module that receives a fragment of information may subject it to a series of processing stages that depend on the profile of the user requesting the service, this is because the system bears two alternative treatments: replication or the information dispersal algorithm (IDA) and depending on the service level agreed with each user, the node receiving a fragment selects one of these, in replication n identical copies of the fragment are created, which we will call blocks, instead, dispersion creates a set of n different bits chains, also called blocks, such that any m of them are enough to reconstruct the original unit, it is important to emphasize that both functions parameters are configurable, in the case of IDA, the only condition is that 1<m<n and each fragment may vary approximately from 0.5 MB up to 500 MB.

59. The high-performance process for the treatment and storage of data in accordance with claim 49, characterized by its application in a corporate memory.

60. The high-performance process for the treatment and storage of data in accordance with claim 49, characterized by its application in PACS (Picture Archiving and Communications Systems) in clinics, health centers, hospitals, institutes, since it is a cloud storing service based on the system.
